(19) United States
(12) Patent Application Publication
(10) Pub. No.: US 2006/0031097 A1
(43) Pub. Date: Feb. 9, 2006

(54) Practice management system

(75) Inventors: Randolph B. Lipscher, Austin, TX (US); Eric Wohl, Austin, TX (US)

Correspondence Address: TOLER & LARSON & ABEL L.L.P., 5000 PLAZA ON THE LAKE STE 265, AUSTIN, TX, 78746, US

(73) Assignee: CATALIS, INC., Austin, TX (US)

(21) Appl. No.: 11/187,610

(22) Filed: Jul. 22, 2005

Related U.S. Application Data
(60) Provisional application No. 60/599,982, filed on Aug. 9, 2004.
(60) Provisional application No. 60/670,455, filed on Apr. 12, 2005.

(51) Int. Cl. G06Q 50/00

(52) U.S. Cl. 705/2

(57) ABSTRACT

The disclosure is directed to a computer-implemented method of generating a prescription refill. The method includes providing a patient interactive interface, receiving a prescription refill request via the patient interactive interface, initiating a refill authorization request associated with the prescription refill request, and receiving a refill authorization.

### CROSS-REFERENCE TO RELATED APPLICATION(S)

The present application claims priority from U.S. Provisional Patent Application No. 60/599,982, filed Aug. 9, 2004, entitled “PRACTICE MANAGEMENT SYSTEM,” naming inventors Randolph B. Lipscher and Eric Wohl, which application is incorporated by reference herein in its entirety.

The present application claims priority from U.S. Provisional Patent Application No. 60/670,455, filed Apr. 12, 2005, entitled “PRACTICE AND ENCOUNTER MANAGEMENT SYSTEMS,” naming inventors Eric Wohl, which application is incorporated by reference herein in its entirety.

### FIELD OF THE DISCLOSURE

This disclosure, in general, relates to practice management systems.

### BACKGROUND

Managing a medical practice involves activities such as scheduling patient visits, verifying payer information, interacting with payers, interacting with pharmacies, and receiving patient requests. With increasing medical costs, such as medical malpractice insurance, physicians are interested in offsetting these costs by visiting with more patients and improving efficiency in collection rates. In addition, physicians′ profits increase with reductions other expenses, such as office personnel and labor. However, traditional methods for managing medical offices remain inefficient and expensive.

Traditionally, physicians have employed receptionists and other professionals to answer telephones and greet patients. A receptionist, for example, handles appointment scheduling and phone calls regarding medication refills. Receptionists typically interact with patients on the phone in order to schedule an appointment. In addition, the receptionist collects insurance verification information, subsequently calls an insurance company and determines the validity and terms of a patient's insurance plan. In another example, a patient contacts a physician's office regarding a medication refill. In response to the refill request, the receptionist or other office personnel typically locates the file relating to the patient and takes the file to a physician. The physician determines whether a refill is permissible, at which time the physician or another office person may call the pharmacy and authorize the refill.

In another example, a pharmacy may contact a physician's office to verify a prescription. Again the receptionist typically gathers the file and provides the information or has a physician call the pharmacy to verify the prescription. In each case, the cost of labor associated with the office activity adds to office expenses.

Another difficulty faced by physicians is inefficient collections. Various payers, such as insurance companies and government entities, have differing rules for filing valid insurance claims. Due to a large variation in payer rules, physicians often have difficulty in determining which tests and treatments are authorized by the payer's plan. As such, physicians run the risk of not being paid for a specific procedure or having to charge the client outside of the insurance system.

As such, an improved practice management system would be desirable.

### SUMMARY

In a particular embodiment, the disclosure is directed to a computer-implemented method of generating a prescription refill. The method includes providing a patient interactive interface, receiving a prescription refill request via the patient interactive interface, initiating a refill authorization request associated with the prescription refill request, and receiving a refill authorization.

In another exemplary embodiment, the disclosure is directed to a practice management system including a processor, a network interface accessible to the processor, and memory accessible to the processor. The memory includes computer implemented instructions configured to provide a patient interactive interface, and computer implemented instructions configured to interact with a medical encounter management system to facilitate prescription refill authorization.

In a further exemplary embodiment, the disclosure is directed to a system including a practice management system including a patient interactive interface configure receive a prescription refill request, and an encounter management system configured to communicate with the practice management system. The encounter management system includes a medical interactive interface configured to provide notification of a prescription refill request and configured to receive a prescription refill authorization.

In another exemplary embodiment, the disclosure is directed to an interface device including a display configured to display a medical findings entry interface including a list of action items including at least one refill authorization request and a data entry area configured to display entry objects associated with a selected action item from the list of action items. The data entry area is configured to display a refill authorization screen in response to a selection of the at least one refill authorization request.

In a further exemplary embodiment, the disclosure is directed to a computer-implemented method of patient interaction. The method includes receiving a user information and a user selection associated with appointment scheduling, providing a set of calendar options and receiving a selected appointment based on the set of calendar options.

Another exemplary embodiment includes a computer implemented method of procedure verification. The method includes receiving a code associated with a patient encounter, evaluating the code based at least in part on a set of payer rules and providing an indicator in response to evaluating.

A further exemplary embodiment includes a computer implemented method of providing test results. The method includes receiving user information and a user selection associated with a test result, determining whether a test result is available, determining whether the test result is accessible in response to determining that the test result is available and providing the test result when the test result is accessible.

In another exemplary embodiment, the disclosure is directed to a computer implemented method of providing an encounter management system. The method includes receiving a billing code from a practice management system, converting the billing code to a discrete finding and storing the discrete finding in an encounter management system.

### BRIEF DESCRIPTION OF THE DRAWINGS

FIGS. 1 and 2 are block diagrams illustrating exemplary embodiments of network systems for use in a medical office setting.

FIG. 3 is a block diagram depicting an exemplary embodiment of a practice management system.

FIGS. 4-12 are flow diagrams depicting exemplary methods for use by a practice management system.

FIGS. 13 and 14 are general diagrams illustrating exemplary interface screens.

FIGS. 15 and 16 are flow diagrams illustrating exemplary methods for use by a practice management system.

FIGS. 17 and 18 are general diagrams illustrating exemplary interface screens.

FIGS. 19A, 19B and 19C include illustrations of exemplary mappings between billing codes and discrete findings.

FIGS. 20 and 21 include illustrations of exemplary interfaces for use in medical practice systems, such as the exemplary medical practice system of FIG. 1.

FIG. 22 includes an illustration of an exemplary method for use in medical practice systems, such as in medical practice system illustrated in FIG. 1.

### DESCRIPTION OF THE DRAWING(S)

In a particular embodiment, the disclosure is directed to a system including a practice management system and an encounter management system. The practice management system includes interactive interfaces configured to schedule patient appointments and receive prescription refill requests. The encounter management system is configured to communicate with a medical interface device to provide notification of a prescription refill request and to receive prescription refill authorization.

In another embodiment, the disclosure is directed to a method of authorizing a refill of a prescription. The method includes providing a patient interactive interface, receiving a prescription refill request via the patient interactive interface, transferring a refill authorization request associated with the prescription refill request to a medical professional interface device, and receiving a refill authorization.

In another embodiment, the disclosure is directed to a medical data entry interface displayed on a medical interface device. The medical data entry interface includes a list of pending activities that include at least one request for a refill and, when the refill request is selected, an entry interface that allows acceptance, denial, or modification of the refill request.

In one particular embodiment, the disclosure is directed to a medical practice system including a medical encounter system and a practice management system. The medical practice system is configured to receive historical billing data, convert or map the historical billing data to discrete findings and store those discrete findings in an encounter database. The medical practice system may further provide an interface accessible by healthcare providers to confirm mapped discrete findings. The disclosure may also be directed to an interface for reviewing mapped discrete findings.

In another exemplary embodiment, the disclosure directed to a method of populating an encounter management system. The method includes receiving a billing code, mapping the billing code to a discrete finding, and storing the discrete finding in an encounter management system. The method may further include providing an interface including controls configured for review of mapped discrete findings.

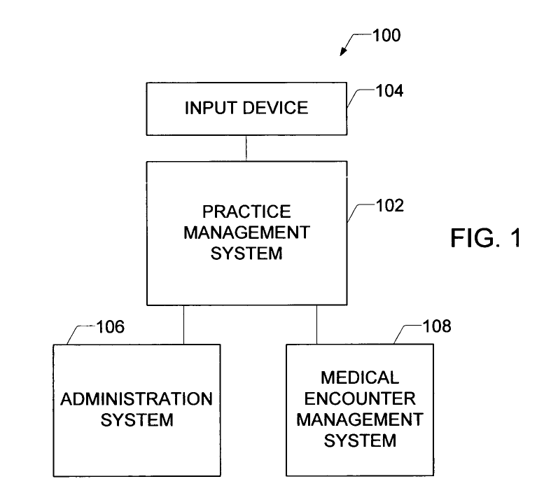

FIG. 1 depicts an exemplary embodiment of a system 100 that includes a practice management system 102, an input device 104, an administration system 106, and a medical encounter management system 108. The practice management system 102 interacts with the input device 104, the administrative system 106 and the medical data entry system 108 to perform various functions associated with the management of a medical practice, such as billing, appointment scheduling, prescription verification, refill authorization, and insurance verification. In one exemplary embodiment, the practice management system 102, the administration system 106 and the medical encounter management system 108 are computational systems, such as servers and interface devices that interact over a local area network. In another exemplary embodiment, the practice management system 102 may interact with the administration system 106 and the medical encounter system 108 over a wide area network or a global network.

The input device 104 interacts with the practice management system 102 over a remote connection, including via a telephone network or via a data network. For example, the input device 104 may be a telephone that interacts with an interactive voice menu provided by the practice management system 102 over a public switch telephone network. In this example, a user of the input device 104 interacts with the practice management system 102 using a voice response or a touch-tone response unit. In another exemplary embodiment, the input device 104 is a computer interface device, such as a personal computer, personal digital assistant (PDA), tablet PC, or web-enabled mobile phone, that interacts with the practice management system 102 over a network, such as a wide-area network or the Internet. In this exemplary embodiment, the practice management system 102 may provide a web-based interface to the input device 104 via the data network. In this manner, the user of the input device 104 may interact with the practice management system 102 through web-based option selection and data entry.

In one exemplary embodiment, the practice management system 102 functions to schedule patient appointments. A physician may supply a set of available appointment times or a calendar file or program to the practice management system 102. Subsequently, users of input devices 104 may interact with the practice management system 102 to request and arrange for appointment times. For example, a patient using an input device 104 may interact with a web page provided by the practice management system 102 to select an appointment time. In response to the selection, the practice management system 102 performs pre-appointment activities, such as insurance verification and collection of preliminary medical findings, such as chief complaint data, and seeks authorization of a primary care physician in the case of a specialist practice.

In another exemplary embodiment, the practice management system 102 may function to obtain medication refill authorization. For example, a user using an input device 104, such as a telephone or a computational device having web access, may request a prescription refill through an interface provided by the practice management system 102. The practice management system 102 may interact with a medical encounter system 108 to request authorization from a physician or medical professional. For example, the practice management system 102 may query the medical encounter system 108 that provides an interface to a physician to enter the desired authorization information. The medical encounter system 108 communicates with the practice management system 102 to indicate that an authorization has been received in response to the physician authorization. The patient may be notified via the input device 104, such as through a call-back phone call, an email notification, or a message on a web page. In addition, the practice management system 102 may automatically forward a prescription via an electronic system, via facsimile or via email to a pharmacy.

In a further exemplary embodiment, the practice management system 102 may provide an interface to a user through the interface device 104 to enter information, such as past medical history, preferred pharmacy information, chief complain information, insurance information, and patient family medical and social history (PFMSH) information. For example, the practice management system 102 may provide a web-page interface over a network to interface device 104 for use by a patient.

In another exemplary embodiment, the practice management system 102 may function to assist in billing functions. For example, the practice management system 102 may include a billing system or may interact with an administration system 106. Medical data acquired through the medical encounter system 108 may be used to assign billing codes to procedures and medical activities associated with a patient visit. In one exemplary embodiment, discrete input findings are mapped to disease, procedure, and order codes, such as ICD-9 and CPT codes. The disease, procedure, and order codes may be provided as part of the billing function or these codes may be interpreted in accordance with a payer's preferences to establish billing information and amounts. Practice management system 102 and/or the administration system 106 may interact to prepare bills for submission to payers, such as insurance companies or government entities, using the medical data stored on the medical encounter system 108 or billing codes associated with the findings and procedures.

In one particular embodiment, the practice management system 102 may interact with external resource systems, such as payer systems, external management systems, pharmacy systems, government disease control systems, centralized or generalize medical data repositories and remote information databases. For example, a practice management system may interact with an external resource system, such as an insurance system, to file billing or payment requests. In one particular embodiment, the practice management system 102 interacts with an external management system to acquire payer rules. The payer rules are, for example, rules associated with a payer plan, such as an insurance plan or a government medical plan, that determine whether a procedure is covered for a given patient condition or a set of medical findings. Using the payer rules, the practice management system may provide indications, such as via the medical encounter system 108, to physicians to indicate possible conflicts between payer rules and procedures requested by the physician. For example, the system may provide a message, coloration on an order code, or a fly out window indicating a conflict with payer rules. In another example, the physician interface may include a summary or narrative page that includes an indication, message, or icon that indicates conflict with payer rules. In these examples, additional information may be provided in a fly out window or separate window in response to selection of text or an icon indicating conflict with payer rules. In some cases, a physician may acquire additional findings to support the desired procedure or select an authorized equivalent procedure.

In another exemplary embodiment, the practice management system 102 interacts with a remote database repository for medical records. For example, a general database for storing patient medical records may be established by an insurance agency or government entity. The practice management system 102 may interact with the medical encounter management system 108 to acquire medical findings data, prepare and format the data for storage, and store the medical data on the remote database repository. For example, a patient may request transfer of medical history to another physician. The practice management system 102 may be authorized, by the patient through an input device 104 or by office personnel, to transfer the medical data to a repository accessible by other medical professionals.

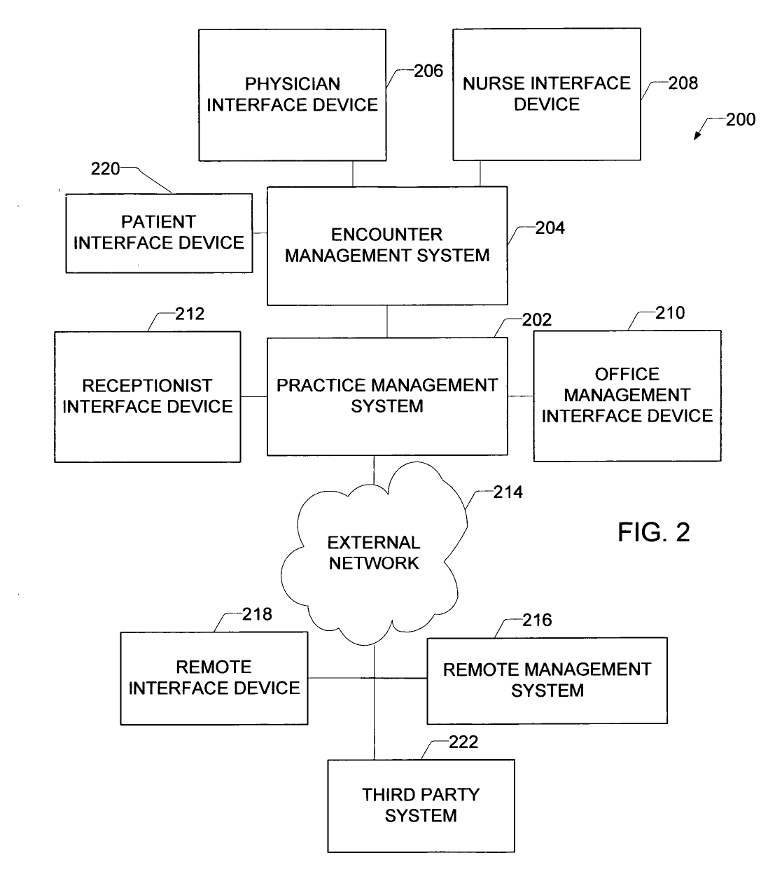

FIG. 2 depicts an exemplary system 200 that includes a practice management system 202. The practice management system 202 interacts with a variety of interfaces (206, 208, 210, 212, and 220) and an encounter management system 204. For example, the practice management system 202 may interact with the encounter system 204, the physician interface device 206, the nurse interface 208, the reception interface device 212 and the office management interface device 210 via a local area network. In addition, the practice management system 202 may interact with a remote interface device 218, a remote management system 216, and third party systems 222 via an external network 214.

The practice management system 202 and the encounter management system 204 may, for example, be server systems and computational systems that communicate via the local area network. In one exemplary embodiment, the encounter management system 204 and the practice management system 202 are co-located on the same server.

In one particular example, the encounter management system 204 interacts with medical interface devices associated with medical personnel, such as physicians and nurses. The encounter management system 204 communicates with interface devices, such as physician interface device 206 and nurse interface device 208, to collect and display medical findings data associated with patients. Medical findings data includes discrete input data that may be entered using bi-state (e.g., select/unselect item or yes/no input), tri-state (e.g., yes/no/unselected input), text, numeric, graphical, radio-button (e.g., select one item from a list), or drop-down menu control elements to input medical information. In a particular embodiment, medical findings data may be associated with disease classification codes, such as ICD9 and CPT codes.

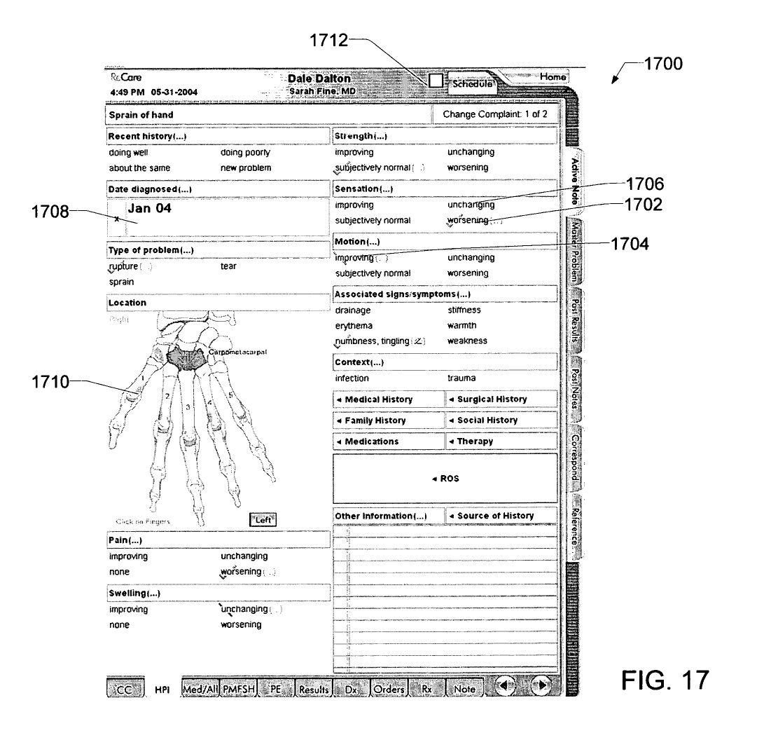

In one embodiment, the physician interface device 206 and the nurse interface device 208 are wireless tablet-based personal computers, personal digital assistants (PDA) or other hand-held electronic devices that interact with the encounter management system 204 via a network that includes a wireless network portion. The interface provided by the encounter management system 204 may include discrete input interfaces that provide data entry controls for entering medical findings data, such as bi-state, tri-state, text, numeric, graphical, drop-down-menu, and radio button controls. For example, the medical findings data may include discrete findings, such as conditions, states, disease characteristics, diagnoses, medical/family/social history information, prescription data, medical orders, and test results. An exemplary interface is described in relation to FIG. 17. The practice management system 202 may interact with the encounter management system 204 to provide data to be provided to interface devices, such as physician interface device 206 and nurse interface device 208.

In addition, the practice management system 202 may interact with a receptionist interface device 212 and an office management interface device 210. The receptionist interface device 212 and the office management interface device 210 may be wired or wireless interface devices, such as personal computers, tablet-based personal computers, and PDAs. The practice management system 202 may interact with these systems, such as the encounter management system 204, the receptionist management interface 212 and the office management interface device 210, to perform functions, such as patient appointment scheduling, refill authorization, billing, insurance verification, patient medical data entry, and prescription verification.

Further, the practice management system 202 may interact with remote interface device 218 or remote management system 216 via an external network 214. In one exemplary embodiment, the practice management system 202 interacts with a web-based interface device 218 via an external data network 214. In another exemplary embodiment, the practice management system 204 interacts with a telephonic interface device 218 via a public switch telephone network 214. In a further exemplary embodiment, the practice management system 202 interacts with a remote management system 216 via external data network 214.

For example, a patient may desire a prescription refill and submit a refill request via a remote interface device 218 displaying a web-page provided by the practice management system 202. The practice management system 202 may interact with the encounter management system 204 to provide a refill request indication on an interface provided to a physician interface device 206. A physician using the physician interface device 206 may select the refill authorization request and provide desired data to accept, modify or deny the refill request. The data provided by the physician, via the physician interface device 206, may be stored in the encounter system 204. The practice management system 202 may interact with the encounter management system 204 to determine the status of the refill request authorization and provide an indication to the patient via a web-page interface or an email. In addition, the practice management system 202 may interact with a pharmacy system and electronically transmit a refill authorization to the pharmacy system, such as via the external network 214.

In another example, a patient may schedule an appointment. Using a telephonic interaction or a webpage interaction, the patient accesses the practice management system 202 to determine available appointment times. For example, the practice management system 202 requests information indicating the urgency of the appointment and provides a set of scheduling options to the patient based on the urgency of the appointment and a set of available appointment times. The patient selects the desired appointment time and the practice management system 202 interacts with the receptionist interface device 212 to acquire authorization for scheduling the appointment. In addition, the practice management system 202 may collect insurance information from the patient and act to verify the insurance information prior to the scheduled appointment. For example, the practice management system 202 may interact with a remote insurance system via the external network 214 to determine whether the insurance provided by the patient is valid.

If the insurance information is not valid, in one embodiment the practice management system 202 may interact with the receptionist interface device 212 to display notification information, which the receptionist may use to resolve the discrepancy by, for example, contacting the patient or the insurance company via email or telephone. In another embodiment, the practice management system 202 may interact with the remote interface device 218 to indicate that the insurance information could not be verified and providing the user with the opportunity to re-enter or correct the information. This corrected information is then resubmitted to the verification process just described.

In another exemplary embodiment, a pharmacy may access the practice management system 202 via a phone interface or a web-based interface. The pharmacy may provide information, such as a prescription verification and a pharmacy verification, and, in return, receive verification information associated with the prescription. In one exemplary embodiment, the practice management system 202 may interact with the encounter management system 204 to notify a physician or a nurse via the interface devices 206 or 208 about the verification activity.

In a further exemplary embodiment, the physicians and nurses, via the physician interface device 206 or the nurse interface device 208, may enter medical findings information into the encounter management system 204. This medical findings information may, for example, include findings codes associated with the medical findings. Typically, payers, such as insurance companies and government entities, agree to pay for certain procedures based on a specific set of findings observed in a given patient exam. The practice management system 202 may include a set of payer rules that associate procedure codes with sets of finding codes. When procedures are ordered in conjunction with a patient visit and a set of findings associated with that patient are stored in the encounter management system 204, the practice management system 202 may compare the findings and procedure codes to determine a likelihood of payer rule compliance and payer payment. In one exemplary embodiment, the practice management system 202 interacts with the encounter management system 204 to provide an indication as to whether a procedure is likely to be allowed by a particular payer. In one particular embodiment, the practice management system 202 indicates specific finding codes that are associated with an allowable procedure. The practice management system 202 may acquire the payer rules from a remote management system 216. In addition, the practice management system 202 may interact with the remote management system 216 to provide data sets associated with authorized pairings of procedural and findings codes. In one exemplary embodiment, the remote management system 216 learns the payer rules based on authorized pairings received from a plurality of medical practices and provides a set of learned payer rules to the practice management system 202. Each set of learned payer rules may be associated with a distinct payer or payer plan.

In a further exemplary embodiment, the practice management system 202 interacts with the encounter management system 204 to acquire findings and procedural codes and to prepare billing statements in conjunction with the office management interface 210. In another exemplary embodiment, the practice management system 202 may compare billing codes provided by the office management interface device 210 to those finding and procedural codes received from the encounter management system 204. The practice management system 202 may use these sets of codes to determine a realization rate or efficiency with which billing is being performed. For example, the practice management system may calculate an expected income based on findings and compare the expected income to actual payments received from payers.

In another exemplary embodiment, the practice management system 202 interacts with a general medical records repository, such as a universal medical records database or an insurance company database. The practice management system 202 may prepare and format records to be stored in the general medical records repository based on data acquired from the encounter management system 204.

As illustrated, the practice management system 202 may have access to third party systems 222. The medical encounter system 204 may be accessible by a healthcare provider interface 206 and a patient interface 220. The practice management system 202 is typically configured to communicate with third party systems 222, such as insurance systems, third party payers, government entities, and billing service providers. The practice management system 202 is often managed via a management interface 210. The management interface 210 typically permits entry of billing codes that coincide with treatment of a patient. Exemplary coding includes diagnostic codes, such as ICD-9 codes, procedural codes, such as current procedural terminology (CPT) codes, and pharmaceutical codes, such as American hospital formulary service (AHFS) codes. CPT codes include evaluation and management (E&M) codes and material codes, such as healthcare procedural coding system (HCPCS). Various coding systems are provided by insurers, government agencies and standards bodies. For example, coding standards are provided by the healthcare financing administration (HCFA).

In contrast, the medical encounter system 204 typically includes a database that stores discrete findings associated with patient encounters. For example, when a patient visits a healthcare provider, the healthcare provider may gather data associated with a patient's medical history, current ailments and complaints, family and social histories, and vital statistics. These findings are stored as discrete entries in a database. In one exemplary embodiment, a patient may be provided with an interface 220 to enter data associated with current complaints and other factors, such as medical, social and family histories, when visiting the healthcare professional's office. Healthcare providers, such as nurses and physicians, may be provided with a healthcare provider interface 206 or 208 in which the healthcare provider may confirm the findings entered by the patient and enter additional findings, such as vital statistics, review of systems findings, history of present illness findings, diagnosis, orders, prescriptions and additional chief complaints. The findings acquired from patient and by the healthcare provider may be combined and stored as discrete findings in the encounter management system 204. In a particular embodiment, the discrete findings are stored in a relational database in which a discrete finding code is associated with a patient and the patient encounter.

However, the encounter system often lacks data associated with a patient when, for example, the encounter management system 204 is first installed at a medical practice, or when, for example, a new patient is received by the medical practice. In one exemplary embodiment, legacy practice management systems that include billing codes or billing records provided, for example by a third party payer, the patients previous healthcare providers or the patients themselves may be used to populate the patients record within the encounter management system 204. For example, billing codes may be mapped to discrete findings within the encounter management system 204 and stored in the encounter management system 204 in a record associated with the patient. In one particular embodiment, new discrete findings derived by mapping billing codes are provided in an interface 206 to a healthcare provider for review. The healthcare provider may confirm, change, or edit the mapped discrete findings and store the resulting discrete findings in the encounter management system 204, resulting in a populated patient record.

In one particular embodiment, the practice management system 202 and the medical encounter system 204 are communicatively coupled via a link. For example the practice management system 202 and the medical encounter system 204 may reside on the same server. In another exemplary embodiment, the practice management system 202 and the medical encounter system 204 may reside on separate servers coupled via a network. In a further exemplary embodiment, billing records and data may be stored on a computer readable media, such as an optical or magnetic media at the practice management system 202 and transferred physically to the medical encounter system 204.

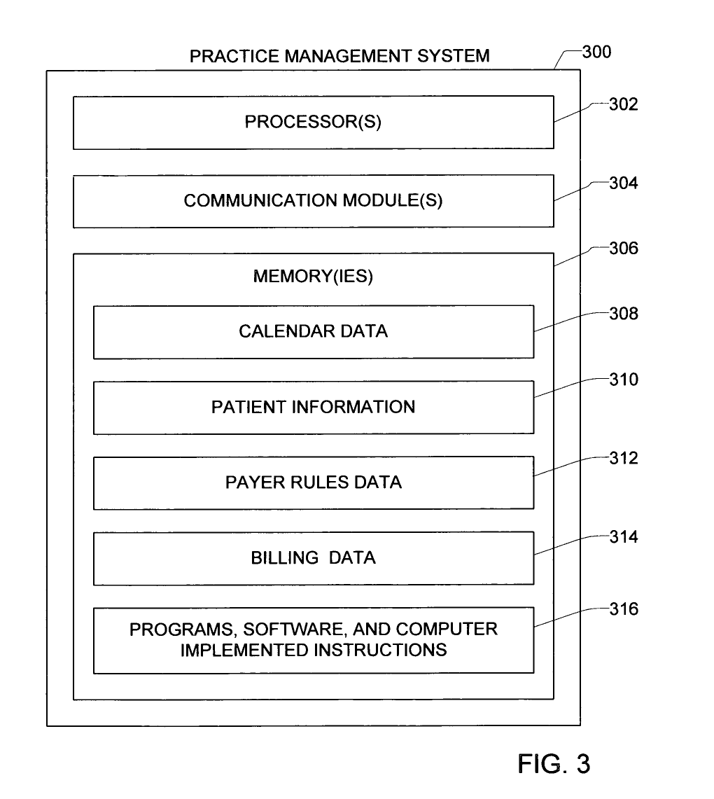

FIG. 3 depicts an exemplary practice management system 300. The practice management system may, for example, be a server system or a computer system that includes processors 302, communications module 304 and computer readable memory 306. The computer readable memory 306 may include calendar data 308, patient information 310, payer rules 312, billing data 314 and programs, software and computer implemented instructions 316.

In this example, the communications circuits 304 are configured to interact with the processor 302 and various networks, such as local area networks, external networks, public switch telephone networks, and wireless data networks. For example, the communications module 304 may include modems that interact with the public switch telephone networks. In another exemplary embodiment, the communications module 304 may interact with an Ethernet, local area network or wireless network.

The computer readable memory 306 may be accessible by the processor and include programs, software and computer implemented instructions 316 that are operable by the processor to perform functions, such as billing, refill authorization, patient appointment scheduling, insurance verification, and payer rule verification. Computer readable memory may include RAM, ROM, flash memory, magnetic memory, optical storage, network storage, and electronic storage. In a particular example, the programs, software and computer implemented instructions 316 may interact with calendar data 308 and provide an interface to a patient for scheduling an appointment via the communications circuits 304. In another exemplary embodiment, the programs, software and computer implemented instructions 316 may interact with patient information 310 to provide a patient data entry interface to acquire patient data, such as insurance information, mailing address information, preferred pharmacy information, and chief complaint or PFMSH information associated with an upcoming patient visit. In a further exemplary embodiment, the programs 316 may provide feedback to an encounter management system based on a set of payer rules 312. In a further exemplary embodiment, the programs 316 may be operable by the processor to interact with billing data 314 and to file payment requests with payers, such as insurance companies and government entities. In another exemplary embodiment, the programs 316 may interact with the communications circuits 304 to provide a pharmacy prescription verification interface. In such a case, data associated with the prescription may be stored on the practice management system 300 or in an encounter management system accessible via the communications circuits 304.

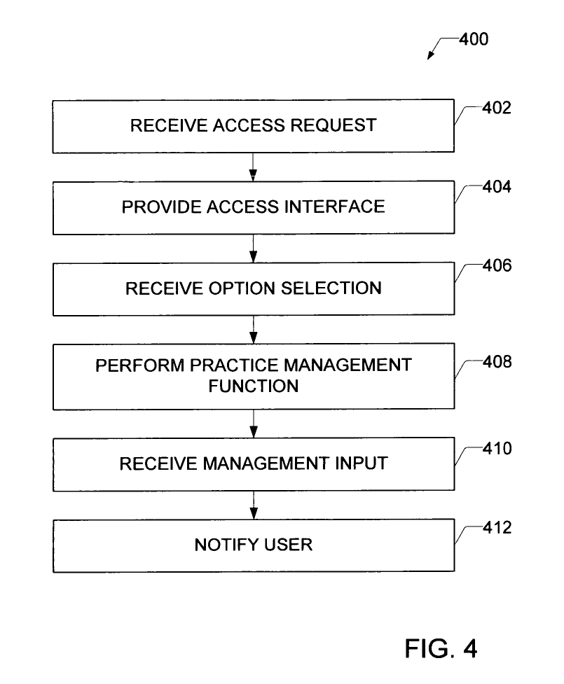

FIG. 4 depicts an exemplary method of operation of the practice management system. The practice management system receives an access request, as illustrated at 402. The access request may, for example, be a telephone call or a webpage access request from a patient or potential patient. The practice management system provides an access interface, as illustrated at 404. The access interface may, for example, be an interactive voice response (IVR) menu provided to a telephone or a webpage provided over a data network. The webpage or telephonic menu may include a set of options that, once selected, is received by the practice management system, as illustrated at 406. In response to receiving the option selection, the practice management system performs a practice management function, as illustrated at 408. For example, practice management functions include verification of a prescription, inquiring or acquiring authorization of a prescription refill, or scheduling a patient appointment. The practice management system may optionally receive management input, as illustrated at 410. For example, in the case of a refill authorization, the practice management system may interact with a physician interface or encounter management system to acquire authorization for providing a refill. In another exemplary embodiment, the practice management system may seek authorization via a receptionist interface to schedule an appointment. Once input has been received and in response to performing the practice management function, the practice management system notifies the user, as illustrated at 412. In one exemplary embodiment, the user may be notified by electronic means such as a webpage interface or email. In another exemplary embodiment, the user may receive a telephone call or be provided telephonic notification, such as via a pager system or short message service.

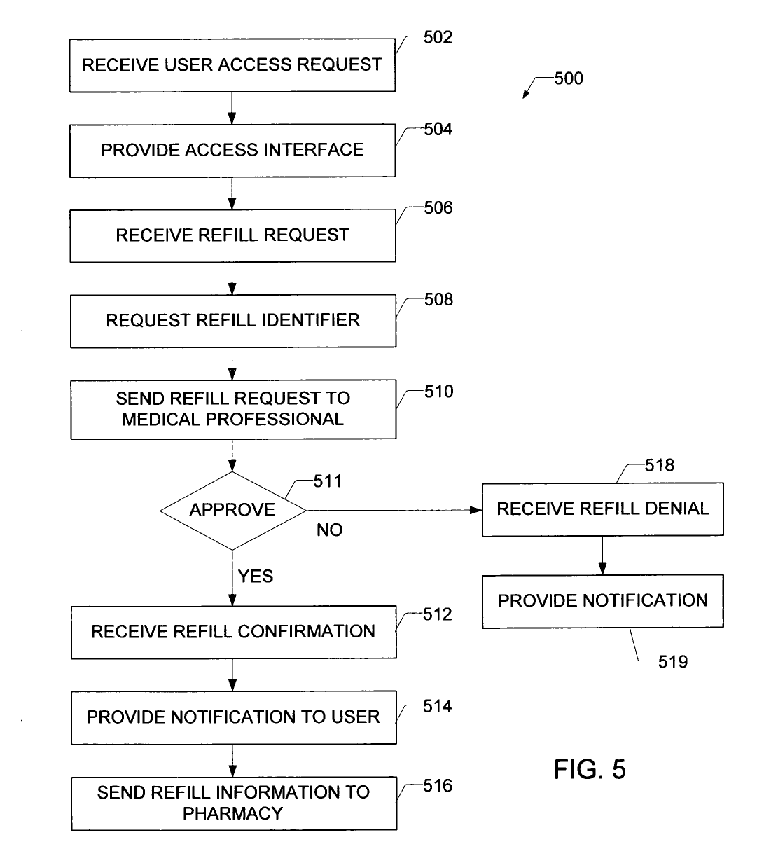

FIG. 5 depicts another exemplary method 500 of operation by the practice management system. The practice management system receives user access requests, as illustrated at 502. The user access request may be a telephonic request or a webpage request. The practice management system provides an access interface, such as a web page or an interactive voice response (IVR) menu, as illustrated at 504. In this exemplary embodiment, the patient requests a prescription refill. The practice management system receives the refill request, as illustrated at 506, and a refill identifier, as illustrated at 508. For example, a refill identifier may be an identification number included on a prescription bottle or on a prescription. In some embodiments, the patient may also be requested to provide log-in data, such as a user name and password.

The practice management system sends the refill request to a medical professional, as illustrated at 510, such as through an encounter management system and/or a physician interface device. The physician may interact with the interface device to accept, modify or deny the refill request, as illustrated at 511. An exemplary interface is illustrated in FIG. 13.

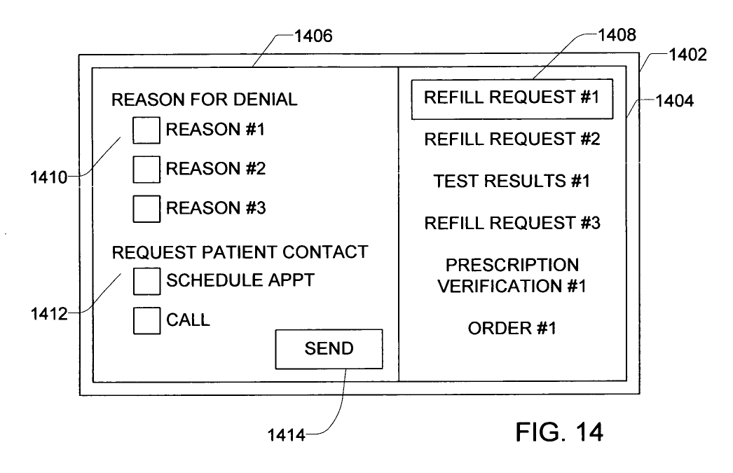

When the refill is denied, the practice management system receives a denial notification, as illustrated at 518. In one exemplary embodiment, denial of a refill initiates a refill denial interface that prompts the physician or medical professional to provide a reason and allows the medical professional to request that the patient schedule an appointment. For example, the refill denial interface may present a set of input controls correlated to common reasons for denying a refill, present a free text control for entering a reason for denying the refill, and include an input control for requesting an appointment or phone consultation. An exemplary interface is illustrated in FIG. 14. For example, the refill denial interface may allow a physician to request a patient visit because a medication appears ineffective, the physician desires more information, or a new dosage schedule is warranted. The denial notification may include the reason for denial and a request to schedule an appointment. The practice management system may notify the patient that refill has been denied, as illustrated at 519, and may request that an appointment be scheduled. For example, the practice management system may provide the notification via an IVR response, an email, a telephone call, or information on a web page.

When the prescription is accepted or modified, the practice management system receives the refill confirmation, as illustrated at 512, and provides notification to the user, as illustrated at 514. In addition, the practice management system may send the refill information to a pharmacy, as illustrated at 516. For example, the refill information may be sent to a preferred pharmacy previously provided by the user or a pharmacy previously handling the prescription.

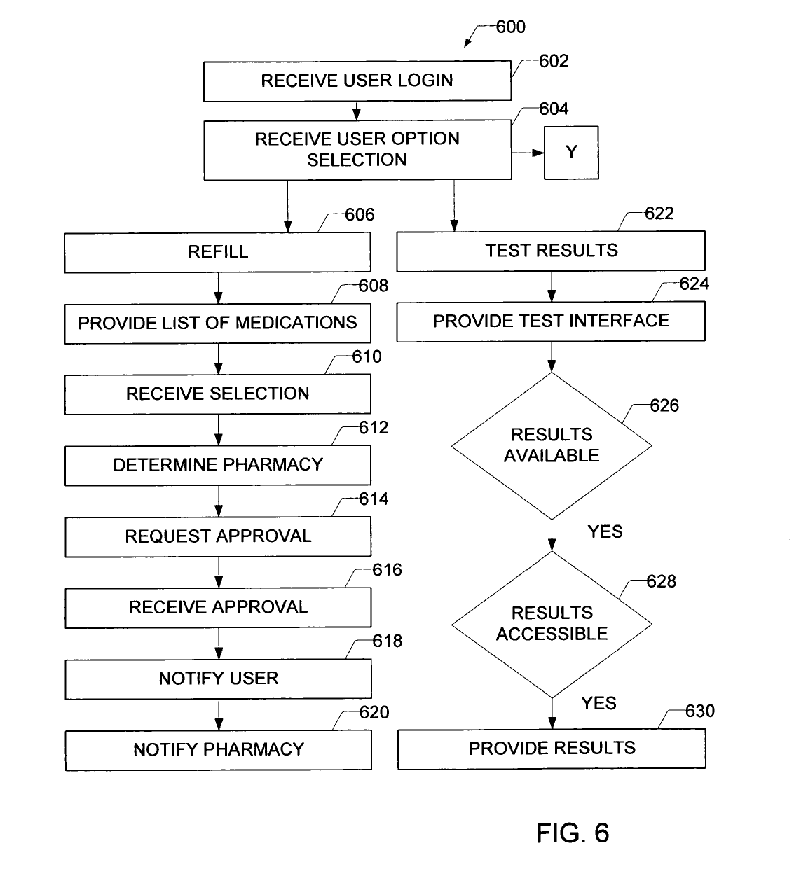

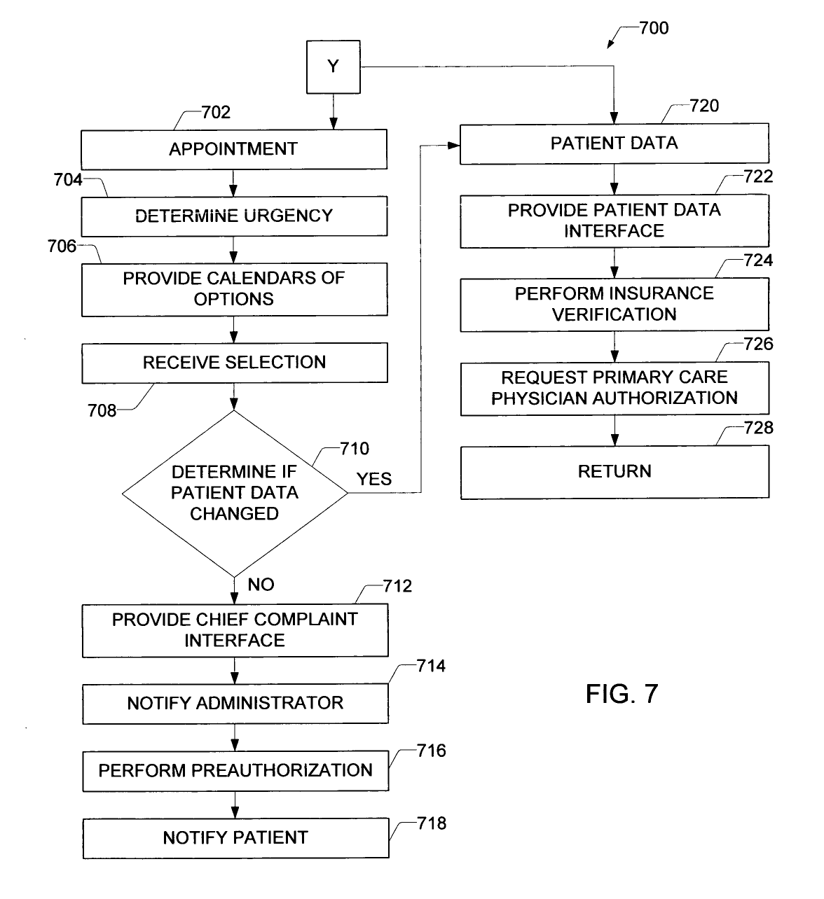

In a further exemplary embodiment, FIGS. 6 and 7 indicate exemplary methods for interacting with a patient. The method 600 includes receiving a user log-in, as illustrated at 602, and receiving a user option selection, as illustrated at 604. For example, the practice management system may receive a phone call and may request a set of user identification numbers. In another exemplary embodiment, the practice management system may receive a webpage request and, in response, provide a web-based interface configured to receive a user name and password.

In the particular embodiment depicted in FIGS. 6 and 7, the user options may include refills 606, test results 622, appointment scheduling 702 or patient data 720. When requesting a refill, as illustrated at 606, the practice management system may provide a list of medications, such as medications currently prescribed to the user, as illustrated at 608. The practice management system receives a selection, as illustrated at 610, and, optionally, determines which pharmacy is associated with the selected medication, as illustrated at 612. In one particular embodiment, the practice management system requests approval from the medical professional, such as through a physician interface device or an encounter management system. The practice management system receives the approval, as illustrated at 616, and notifies the user, as illustrated at 618. For example, the user may be notified by a phone call, an email, or a notification on a web page. The practice management system may also notify the associated pharmacy, as illustrated at 620. For example, the practice management system may interact with a general pharmacy system to provide pharmaceutical information to a database or the practice management system may fax the information to a pharmacy. In an alternative example, the refill may be denied and the patient notified of a reason for the denial and be requested to schedule an appointment or call the medical facility.

In the case of a test result selection, as illustrated at 622. The practice management system provides a test interface, as illustrated at 624. If the results are available, as illustrated at 626, and the results are accessible, as illustrated at 628, the system may provide the results, as illustrated at 630. For example, the results may not be available and the user may be notified as such. In another example, the results may be available but a physician may desire to provide the results to the patient directly. In this case, the patient may be instructed to call the physician. In one particular embodiment, a physician may provide a voice message indicating the results of the test or requesting a phone call from the patient. The voice message may be stored in the practice management system or may be accessed from the encounter management system. When requested, the practice management system may provide the voice message to the patient, such as through the telephone or via a voice data file provided to a webpage.

If a patient desires to schedule an appointment, as illustrated at 702, the system may request information to determine the urgency of the visit, as illustrated at 704. The practice management system provides a calendar having appointment options or a list of available appointment times, as illustrated at 706, and receives a selection, as illustrated at 708. For example, the patient may have previously entered preferred times in patient data stored on the practice management system. In addition, the physician may have provided a calendar of appointment times that takes into account the operating hours of the office, vacations, and other scheduling events. Using calendar data provided by the physician and, optionally, the patient, the practice management system may provide a reduced set of optional appointment times to the patient.

The practice management system may also query the patient to determine patient data has changed, as illustrated at 710. Patient data may include, for example, insurance information, home address, preferred pharmacy information, and patient medical history. If the patient data has not changed, the practice management system may provide a chief complaint interface, as illustrated at 712. A chief complain interface may, for example, request information from the patient that indicates reasons for visit, such as a cough, a pain, a cut or contusion, a physical exam, or other reasons for accessing medical assistance. In an alternate embodiment, the chief complaint step may be performed in conjunction with determining the urgency of the appointment request, as illustrated at 704. The chief complaint information may be stored in the encounter management system. The practice management system notifies the administrator, as illustrated at 714, performs pre-authorization, as illustrated at 716, and notifies the patient of the resulting appointment, as illustrated at 718. For example, an administrator may authorize the scheduling of the appointment, as illustrated at 714. The practice management system may verify the insurance information and the validity of the insurance information provided, as illustrated at 716, and the patient may receive an email, phone call or notification method on a web page to indicate that the appointment has been scheduled, as illustrated at 718. The practice management system may further function to provide an appointment reminder via telephone, page, short message service, or an electronic method, such as email or a web page message.

If it is determined that the patient information has changed or the patient selects the entry of patient data, as illustrated at 720, the practice management system may provide a patient data interface, as illustrated at 722. The patient data interface may, for example, request information associated with a payer, such as an insurance company, information associated with a primary care physician, information associated with preferred pharmacies, and information associated with past medical family and social histories. For example, the practice management system may perform insurance verification upon receiving the insurance information, as illustrated at 724, and in the case of a specialist office, the system may request authorization by a primary care physician, as illustrated at 726. Upon completion of one or more of these steps, the system may return to its previous place, such as allowing a patient to enter a new option or returning to a chief complaint interface during appointment selection.

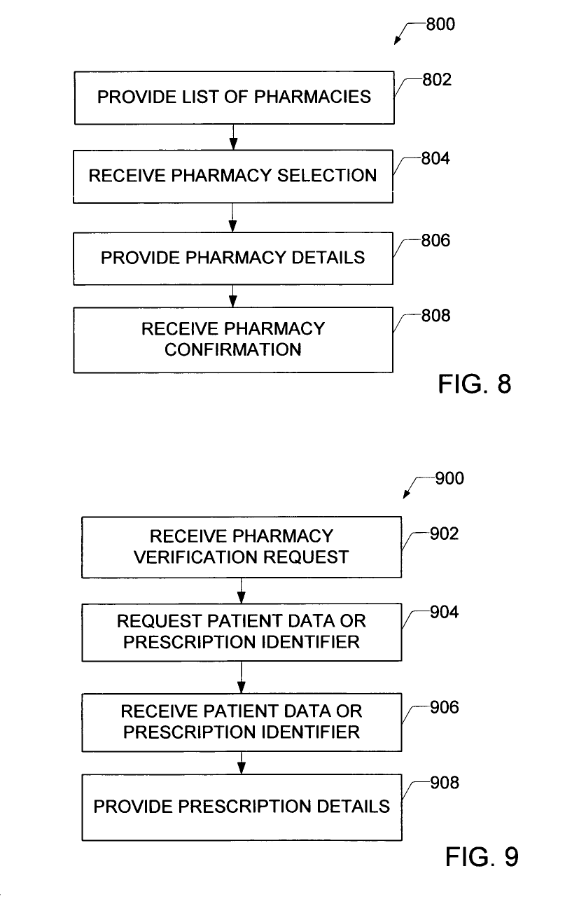

In the case of selecting a pharmacy, the system may provide a list of pharmacies, as illustrated at 802 of FIG. 8. The practice management system receives a pharmacy selection, as illustrated at 804, and may optionally provide pharmacy details, as illustrated at 806. The practice management system receives confirmation of the pharmacy selection, as illustrated at 808. Using this information the practice management system may subsequently deliver prescriptions provided to the patient by a medical professional to the selected pharmacy. In addition, the practice management system may interact with the pharmacy to provide verification of the selected or provided prescription.

In another exemplary method, a pharmacy may be interested in verifying a prescription, as illustrated by the method of FIG. 9. A practice management system receives a pharmacy verification request, as illustrated at 902. For example, a pharmacy may call the practice management system or may access the practice management system via a web-based interface. The practice management system requests patient data and/or prescription identifiers, as illustrated at 904. For example, the practice management system may request a patient name and an identification number associated with the prescription. A pharmacist enters the patient data and the practice management system receives the patient data and/or the prescription identifier, as illustrated at 906. In response to receiving the patient data and the prescription identifier, the practice management system provides prescription details, such as verification of prescription, as illustrated at 908. For example, the practice management system may access the encounter management system to retrieve prescription details. In an alternative embodiment, the practice management system may access the encounter management system, which in turn notifies a medical professional via an interface device. The medical professional may provide the prescription details or authorize the system to provide the details.

The practice management system may also act to compare findings codes with procedure codes. The system may learn a set of payer rules either by providing payer payment histories and billing information to a remote system and acquiring a cumulative set of payer rules from the remote system or by learning the set of payer rules on its own. Payer rules include logic and finding/order pairings associated with a payer, such as an insurance company or government entity. Payers often associate authorization or payment of tests, orders, and procedures with a set of supporting medical findings. Absent documentation of the findings, the payer may refuse to pay for the order, resulting in unpaid accounts receivable for the physician and possibly an unexpected bill for the patient. The practice management system may guide the physician by notifying the physician that a test, order, or procedure is not supported by the set of entered findings, based on a set of learned payer rules associated with the patient's payer. In addition, the practice management system may suggest examining the patient for specific findings to justify the desired test, order, or procedure.

FIG. 10 depicts an exemplary method 1000 for learning payer rules. For example, the system may receive a payer response, as illustrated at 1002. For example, a payer, such as an insurance company or a government entity, may deny payment for a specific procedure. The practice management system accesses finding codes and procedure codes from the encounter management system, as illustrated at 1004, and adapts the payer rules based on the comparison of the payer response to the finding and procedure codes, as illustrated at 1006. In one exemplary embodiment, the payer may also provide a reason for denying the claim or refusing to pay for the procedure. In this case, the payer rules may be adapted based on the payer's response. In alternative embodiments, the practice management system may provide the payer feedback and data to a remote system via an external network. The remote system may learn the payer rules based on feedback from a number of medical facilities and provide the learned rules based on the combined feedback to the practice management system.

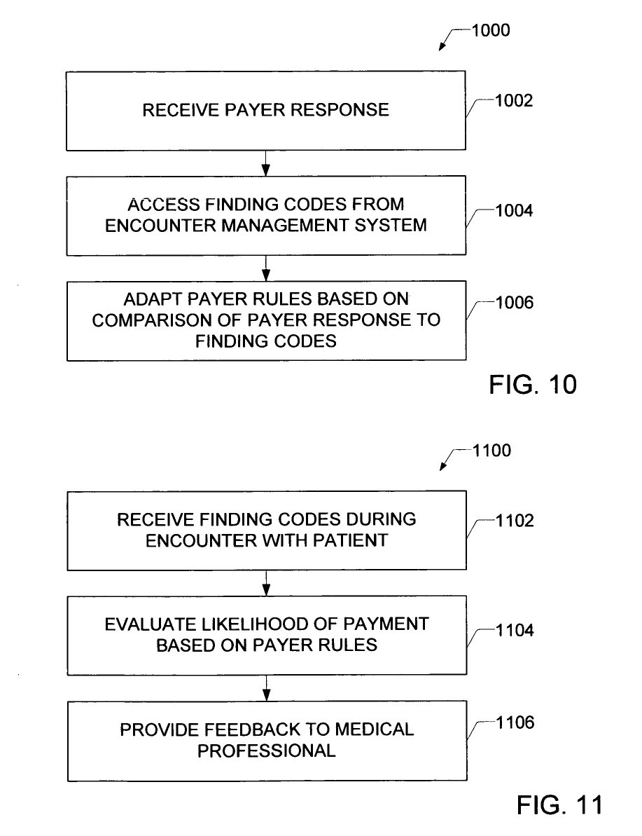

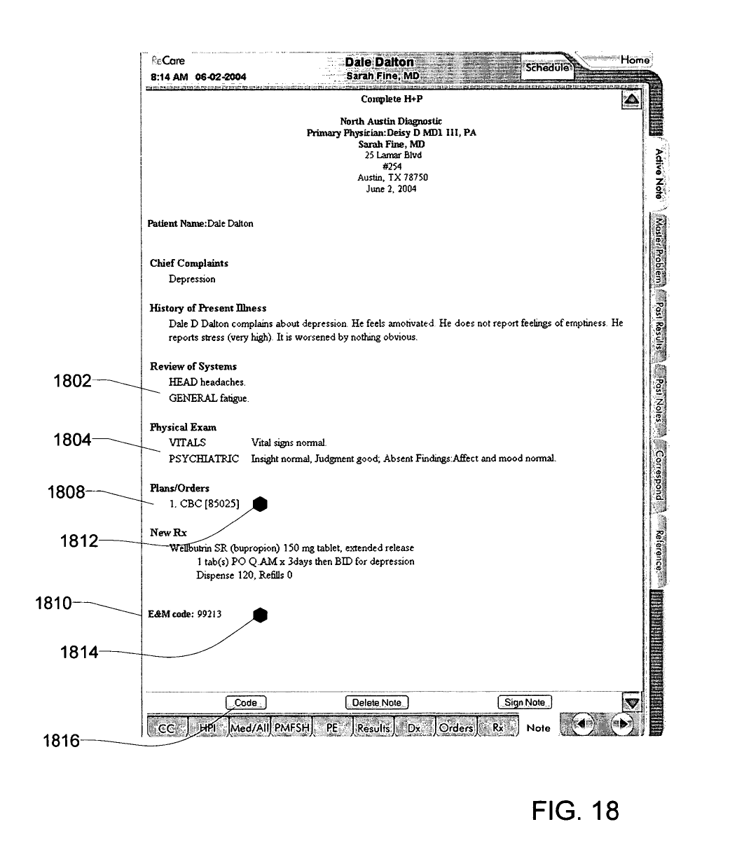

During an encounter with a patient, the physician may desire feedback to determine the procedures that will likely be authorized or particular findings that correspond with procedures that the physician desires to perform. For example, a physician may desire a cholesterol test and the payer rules may restrict such tests to patients above a particular age having a medical or family history of heart disease or stroke. FIG. 11 depicts an exemplary method in which the practice management system receives a set of findings codes and procedure codes during an encounter with a patient, as illustrated at 1102. The practice management system evaluates the likelihood of payment based on the payer rules, as illustrated at 1104, and provides feedback to the medical professional, as illustrated at 1106. For example, the system may determine that the number of findings or the type of findings found during the encounter with the patient are not a significant basis upon which a procedure will be authorized. The practice management system may provide via the physician interface device a list of additional findings that are suggested to justify a particular procedure or may suggest alternate procedures based on payer rules. A similar method may also be performed in conjunction with prescription writing and payer prescription formulary rules. FIG. 18 illustrates an exemplary interface that indicates conflict with payer rules.

For example, in one embodiment, a practice management system interacts with a payer remote management system to retrieve a set of payer authorization rules. In one embodiment, payer authorization rules comprise a list of procedures and a set of prerequisite rules for each procedure such that for each procedure the prerequisite rules comprise a Boolean expression over medical findings that evaluate as “true” if the test is authorized and “false” otherwise. In this embodiment, evaluating the likelihood of payment comprises evaluating these rules using findings from the current patient. In one embodiment, providing feedback includes displaying a list of medical findings whose values for the current patient caused the rules to evaluate to false. In one embodiment, the prerequisite rules for a procedure also includes a list of related procedures that have different prerequisite rules. In this embodiment, providing feedback includes displaying this list of related procedures.

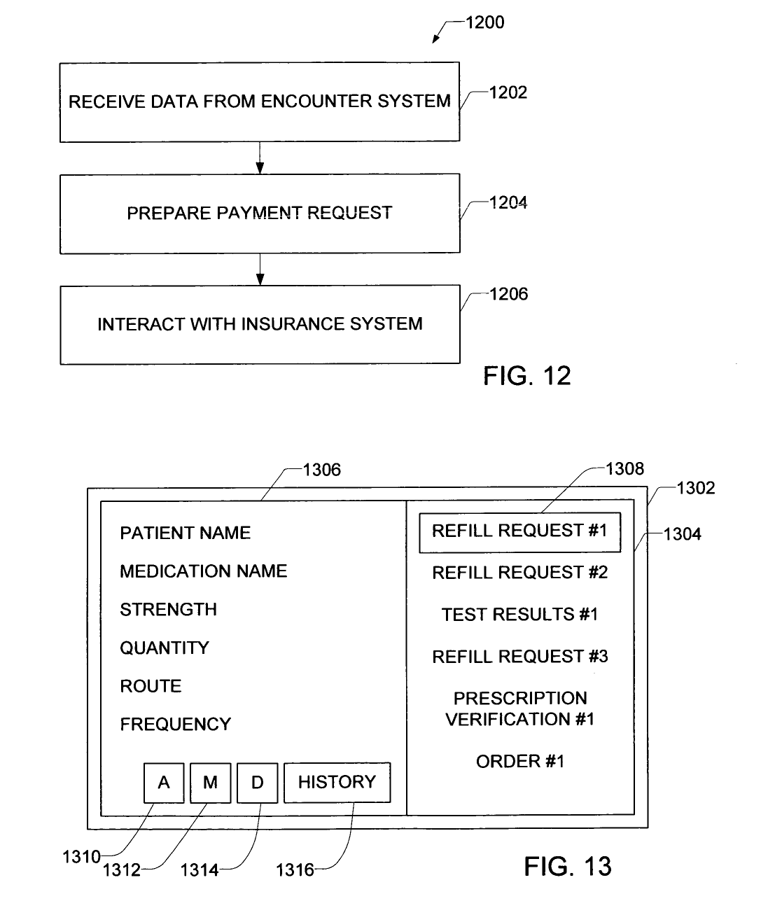

The practice management system may also use the procedure and finding codes to assist in the preparation of bills and request payment from a payer. FIG. 12 depicts an exemplary method in which the practice management system receives data from the encounter system, as illustrated at 1202. The data from the encounter system includes finding codes and procedure codes. The practice management system prepares a payment request, as illustrated at 1204. This payment request may include various billing codes associated with the finding and procedural codes. In one particular embodiment, the practice management system may interact with an insurance system, as illustrated at 1206. For example, the practice management system may interact with an insurance system via an external network to file the payment request or a bill.

In one exemplary embodiment, the system improves billing efficiency and realization rates. By providing guidance during a patient examination to physicians regarding procedure authorization, physicians are more likely to receive payment from a payer more quickly and with less additional paperwork. As a result, accounts receivable may be reduced, leading to higher collection realization rates and improved billing efficiency.

In one exemplary embodiment, the encounter system interacts with a physician interface and a nurse interface. The physician may place orders and request procedures. The encounter system may list these orders and procedures on the nurse interface with interface controls for indicating completion of the order or procedure. The practice management system may access the encounter management system and prepare a bill based on the findings entered by the physician and the completed orders entered by the nurse.

FIG. 13 depicts an exemplary interface for use by a physician at a physician interface device. The interface 1302 includes a listing of pending activities 1304. Pending activities may include a patient exam, prescription refill request, test results, prescription verification request, and message from a medical professional within the office or payer message received from outside the office. For example, if the prescription refill request 1308 is selected, the interface 1302 may display a prescription entry interface 1306 that allows modification, acceptance or denial of the refill request using buttons 1310, 1312, and 1314. In addition, access to patient medical history information may be provided through link 1316. In a particular embodiment, the encounter system provides interface screens associated with findings entry. A control element or icon may be included on each screen to permit access to a pending items interface as depicted in FIG. 17. The pending items interface may include a screen, such as the screen illustrated in FIG. 13. A physician or medical professional may select the control element or icon, access the pending items interface, and access an interface associated with a pending item. For example, a physician may select a prescription refill request 1308 and access a prescription refill entry interface 1306.

If a prescription refill request is denied, the physician may provide a reason for the denial and may request that the patient contact the physician or schedule an appointment. FIG. 14 illustrates an exemplary interface in which the entry interface 1406 includes a set of control elements 1410 for selecting a reason for denying the prescription refill and control elements 1412 for requesting that the patient schedule an appointment or contact the medical facility. Alternatively, the interface may include a free text control for entering a reason. The interface also includes a send control element 1414 to send notification to the encounter system and the practice management system. In an alternative embodiment, the physician may send a prescription refill denial without a reason for the denial or without a request for a consultation.

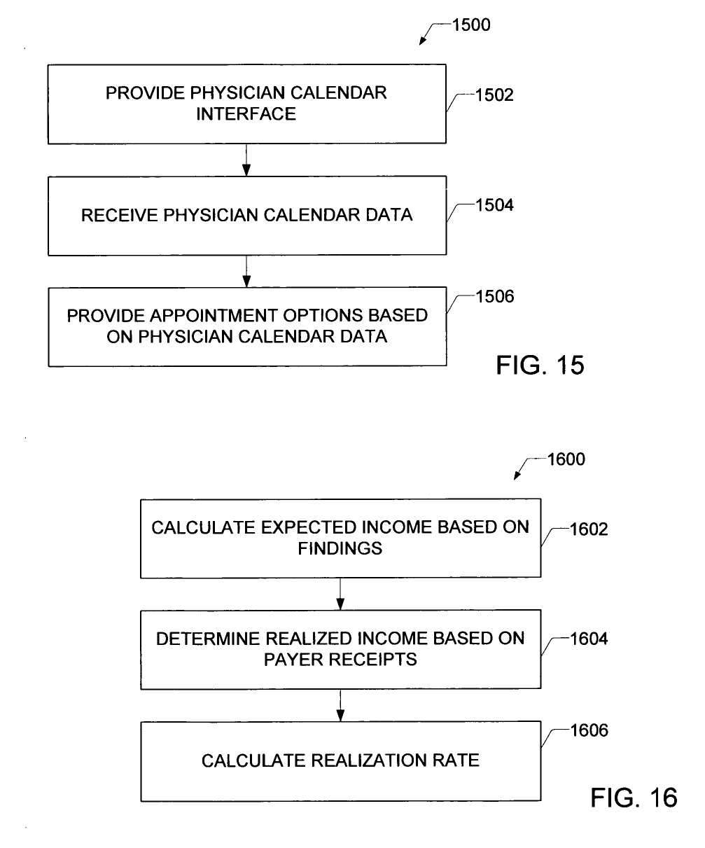

FIG. 15 illustrates an exemplary method for calendar management in a practice management system. The practice management system provides a physician calendar interface, as illustrated at 1502, and receives physician calendar data indicating availability of a physician for accepting appointments, as illustrated at 1504. The practice management system provides appointment options in response to patient requests based on the physician calendar data, as illustrated at 1506.

FIG. 16 illustrates an exemplary method for determining billing efficiency and Performance. The practice management system calculates an expected income based on medical findings data, as illustrated at 1602, and determines realized income based on payer receipts, as illustrated at 1604. The practice management system calculates a realization rate based on a comparison of the expected income and the realized income, as illustrated at 1606.

FIG. 17 is a general diagram illustrating an exemplary medical findings data entry interface. The interface 1700 includes discrete medical findings input controls, such as tri-state controls that may be selected, as illustrated by control 1702, crossed out, as illustrated by control 1704, or deselected, as illustrated by control 1706. Other controls may be used for text entry, as illustrated by control 1708 or image display and graphical selection, as illustrated by control 1710. Discrete input medical findings and other medical findings entered on interfaces, such as the exemplary interface of FIG. 17, may be used to determine billing codes for payment request and disease codes for comparison with payer rules. In addition, the interface 1700 may include a control element 1712 configured to access a pending items interface, such as the exemplary interface depicted in FIG. 13.

FIG. 18 is a general diagram depicting an exemplary summary or narrative interface. The summary or narrative interface may include medical findings data such as review of symptoms data 1802, physical exam data 1804, plans and orders 1808, and a suggested E&M code 1810. In addition, the interface may include indicators 1812 and 1814 that indicate when a code conflicts with payer rules. For example, a plan or order may conflict with payer rules based on missing physical exam data. Control element 1812 may indicate a conflict through, for example, appearance, shape, or color. Similarly, a conflict with an E&M code may be indicated with control element 1814. Additional information may be accessed through buttons, such as code button 1816.

Healthcare providers, such as nurses and physicians, may be provided with a healthcare provider interface in which the healthcare provider may confirm the findings entered by the patient and enter additional findings, such as vital statistics, review of systems findings, history of present illness findings, diagnosis, orders, prescriptions and additional chief complaints. The findings acquired from patient and by the healthcare provider may be combined and stored as discrete findings in the encounter management system. In a particular embodiment, the discrete findings are stored in a relational database in which a discrete finding code is associated with a patient and the patient encounter.

However, the encounter system often lacks data associated with a patient when, for example, the encounter management system is first installed at a medical practice, or when, for example, a new patient is received by the medical practice. In one exemplary embodiment, legacy practice management systems that include billing codes or billing records provided, for example by a third party payer, the patients previous healthcare providers or the patients themselves may be used to populate the patients record within the encounter management system. For example, billing codes may be mapped to discrete findings within the encounter management system and stored in the encounter management system in a record associated with the patient. In one particular embodiment, new discrete findings derived by mapping billing codes are provided in an interface to a healthcare provider for review. The healthcare provider may confirm, change, or edit the mapped discrete findings and store the resulting discrete findings in the encounter management system, resulting in a populated patient record.

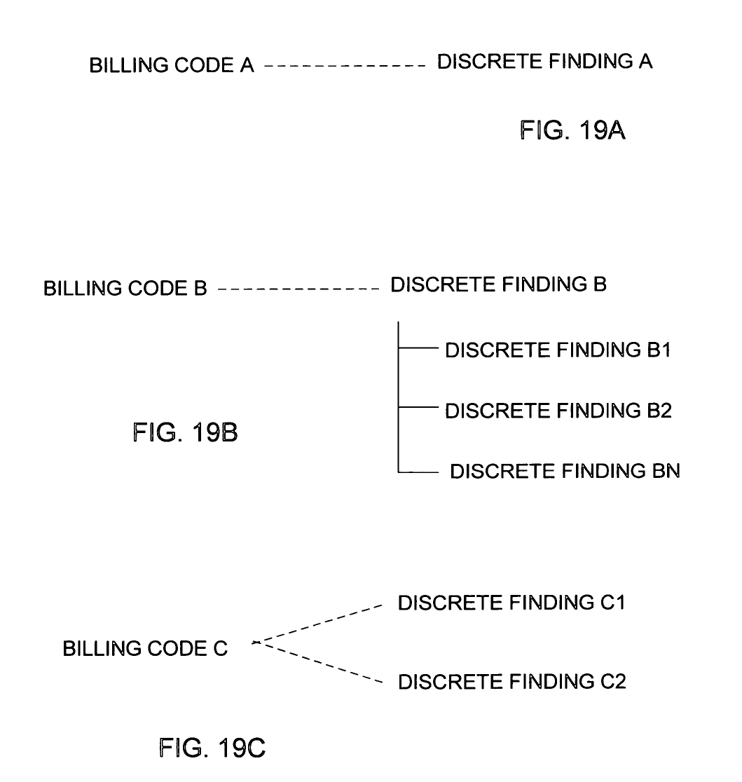

The billing codes may map to discrete findings as exemplified in the illustrations of FIGS. 19A, 19B, and 19C. For example as illustrated in FIG. 19A, a discrete finding A may map one to one with a billing code A. In this example, a billing code may be directly converted or mapped to a particular discrete finding. In another exemplary embodiment, a billing code B, as illustrated in FIG. 19B may map to a discrete finding B. However, the discrete finding B may be a broad category having dependent or child findings, such as discrete findings B 1, B2 and BN. Alternatively, a single billing code C, as illustrated in FIG. 19C, may map to more than one discrete finding, such as discrete findings C1 and C2. Furthermore, a single billing code may map to more than one discrete finding, each having a set of modifiers or child findings.

In one particular embodiment, the encounter system associates an identifier with each of the mapped discrete findings within the encounter database. When the patient's record is next reviewed, the encounter management system provides an interface to the healthcare provider for review of the mapped medical findings.

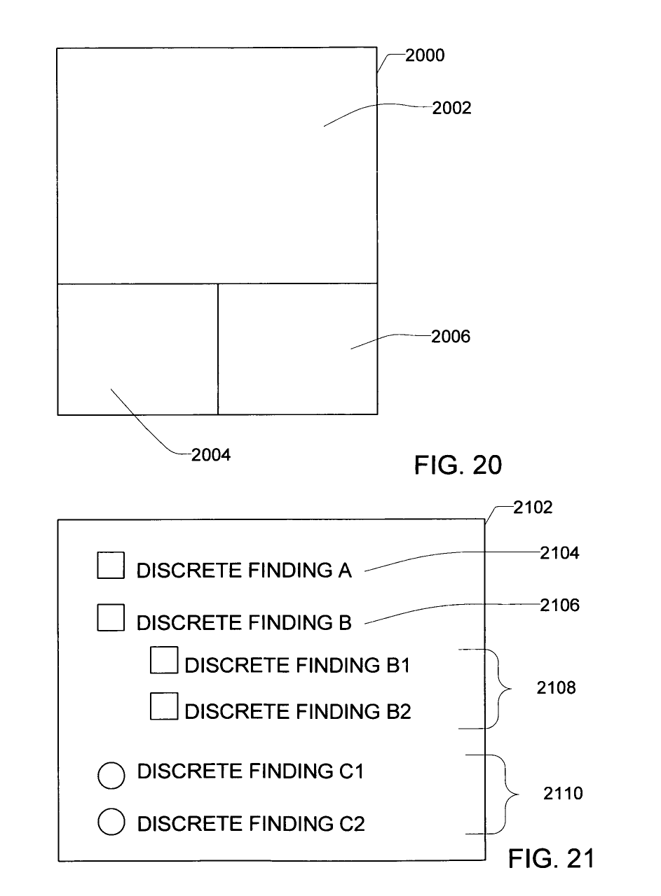

FIG. 20 includes an illustration of an exemplary interface 2000. The interface 2000 includes, for example, an area 2002 including controls for entry of discrete findings associated with a current patient encounter. The interface 2000 may also include, for example, an area including controls for entry and review of orders and tests. Further, the interface 2000 includes an area 2006 for review of mapped discrete findings. In particular, the mapped discrete findings are provided as controls within the interface area 2006. The controls may permit a healthcare provider to accept, delete or edit the mapped discrete finding. Alternatively, a full page interface may be provided to review mapped discrete findings.

For example, FIG. 21 includes an illustration of an area 2102 within an interface that includes controls for reviewing mapped discrete medical findings. The interface area 2102 may, for example, include a control 2104 for reviewing a discrete finding A that maps directly from a billing code A. In another exemplary embodiment, a control 2106 is provided for a billing code that maps to a discrete finding B. When the discrete finding B includes modifiers or other associated discrete findings or subcategories of findings additional controls, such as controls 2108, may be provided for review by the healthcare provider. For example, the healthcare provider may select one or more modifiers associated with discrete findings. In an alternative embodiment, the healthcare provider may identify specific findings within a broad category of findings. In a further exemplary embodiment, the interface 2102 may provide controls 2110 including a set of discrete findings that are derived from a single billing code. For example the controls may permit selection of one or other of the two findings in the alternative. In a further exemplary embodiment (not shown), the controls may provide further access to additional screens, pop up menus or other controls that permit further specification of discrete findings, modifiers to discrete findings or additional discrete findings not derived from billing codes.

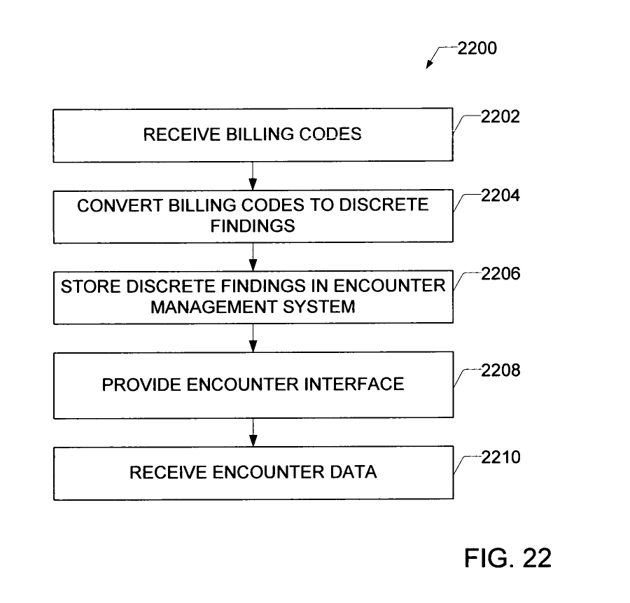

FIG. 22 includes an illustration of an exemplary method 2200 for populating a medical encounter database. Billing codes are received, as illustrated at 2202. For example, billing codes may be received from a legacy practice management system, billing system, third party biller, third party payer, such as an insurance company or government entity, or the patient, or any combination thereof.

These billing codes may be converted or mapped to discrete findings, as illustrated at 2204. In one particular embodiment, a mapping is provided between billing codes and discrete findings. In alternative embodiments, the billing codes may formulaically identify categories, subcategories, and modifiers of discrete findings that may be converted to particular discrete findings.

Once the billing codes are converted or mapped to the discrete findings, the discrete findings may be stored in an encounter management system, as illustrated at 2206. For example, patient medical records may be derived and stored in the encounter management system based on the discrete findings mapped from a patient's billing records. In an alternative embodiment, legacy encounter management systems include discrete findings that may be mapped to discrete findings of a new medical encounter system. In these alternative embodiments, the patient's medical records may be generated by conversion of legacy encounter data. For example, the discrete findings may be stored as numerical identifiers associated with a patient. These medical identifiers may be translated into findings associated with the patient, such as patient medical, family and social histories, medical conditions, chief complaints, prescriptions, tests and orders, addresses and insurance information.

In one particular embodiment, mapped discrete findings are marked or otherwise identified within the encounter management system. During a subsequent patient visit or during a review of the patient's medical record, the encounter management system provides an interface to the healthcare provider for reviewing the mapped encounter data or discrete findings, as illustrated at 2208. For example, the mapped medical or discrete findings may be provided at an interface as controls allowing a healthcare provider to accept, decline, or otherwise edit the mapped discrete findings.

After review, the encountered data including confirmed, declined or edited mapped discrete findings may be returned to the encounter system for storage, as illustrated at 2210. For example, in the course of a patient encounter, the healthcare provider may enter additional encounter data or discrete findings associated with a patient's current condition. During that encounter, the healthcare provider may review the mapped discrete findings and provide the results of that review to the encounter system.

Such a system may also be useful in converting insurance records automatically into discrete findings for use in encounter management systems. For example, an insurance company or third party payer may provide a comprehensive billing record of a patient to healthcare providers providing healthcare to the patient. The respective practice management systems or encounter management systems may convert the combined billing codes into discrete findings for use within the encounter management system. As such, the patients combined medical history may be easily integrated with a healthcare providers medical practice system. In one exemplary embodiment, the billing records are transferred via a network. In another exemplary embodiment, the billing records may be stored on a smart card readable by the practice management system or encounter management system.

Particular embodiments of the above described medical practice system may be useful in automatically transferring medical data or populating encounter management systems with patient medical histories based on billing codes acquired from legacy billing systems. In addition, the particular embodiments of the encounter management systems may be useful in confirming the accuracy of the patients medical record derived from the billing codes. Such systems prevent errors associated with manual data entry, while eliminating the cost and inefficiency of such manual data entry.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadcst permissible interpretation of the following claims and their equivalents, and shall not be restricted or limited by the foregoing detailed description.

1. A computer-implemented method of generating a prescription refill, the method comprising:
providing a patient interactive interface;
receiving a prescription refill request via the patient interactive interface;
initiating refill authorization request associated with the prescription refill request; and
receiving a refill authorization.

2. The computer-implemented method of claim 1, wherein the refill authorization request is displayed on a medical professional interface device

3. The method of claim 1, wherein initiating the refill authorization request includes communicating with a medical encounter management system.

4. The method of claim 1, wherein initiating the refill authorization request includes initiating a control element on a medical interface.

5. The method of claim 4, wherein the medical interface is displayed on a wireless computational device.

6. (canceled)

7. (canceled)

8. The method of claim 1, further comprising providing a refill status notification to a patient.

9. (canceled)

10. (canceled)

11. The method of claim 1, further comprising receiving patient preferred pharmacy information.

12. The method of claim 1, further comprising automatically transferring a prescription associated with the refill authorization to a patient preferred pharmacy.

13. The method of claim 1, wherein the patient interactive interface is provided to a patient via a network external to a medical facility.

14. A practice management system comprising:
a processor;
a network interface accessible to the processor; and
memory accessible to the processor, the memory including;
computer implemented instructions configured to provide a patient interactive interface; and
computer implemented instructions configured to interact with a medical encounter management system to facilitate prescription refill authorization.

15. The practice management system of claim 14, wherein the memory includes computer implemented instructions configured to interact with a pharmacy prescription system to facilitate a prescription refill in response to refill authorization.

16. (canceled)

17. The practice management system of claim 14, wherein the patient interactive interface includes a web-based interface.

18. The practice management system of claim 14, further comprising instructions configured to send a notification in response to the refill authorization.

19. (canceled)

20. (canceled)

21. The practice management system of claim 14, wherein the memory includes calendar data and wherein the patient interactive interface is configured to receive an appointment selection.

22. (canceled)

23. (canceled)

24. A system comprising:
a practice management system including a patient interactive interface configure receive a prescription refill request; and
an encounter management system configured to communicate with the practice management system, the encounter management system including a medical interactive interface configured to provide notification of a prescription refill request and configured to receive a prescription refill authorization

25. The system of claim 24, wherein the practice management system is configured to communicate a prescription refill to a pharmacy system in response to the prescription refill authorization.

26. The system of claim 24, wherein the patient interactive interface includes a web-based interface.

27. The system of claim 24, wherein the patient interactive interface includes a telephonic interface.

28. The system of claim 24, wherein the medical interactive interface includes a medical findings entry interface.

29. (canceled)

30. The system of claim 24, wherein the patient management system is configred to communicate a notification associated with the prescription refill request to a patient in response to the prescription refill authorization.

31-52. (canceled)
